(19) United States
(12) Patent Application Publication
(10) Pub. No.: US 2026/0202312 A1
(43) Pub. Date: Jul. 16, 2026

(54) Method and Apparatus for Monitoring Corrosion Under Insulation

(71) Applicant: 3-SCI LTD, Lee on the Solent (GB)

(72) Inventors: Adrian Robert Bowles, Lee on the Solent (GB); Mark Gregory Maylin, Lee on the Solent (GB); Michael John Hinton, Lee on the Solent (GB); Richard John Caldwell, Lee on the Solent (GB)

(21) Appl. No.: 19/134,723

(22) PCT Filed: Dec. 4, 2023
(86) PCT No.: PCT/EP2023/084090

§ 371 Date: May 31, 2025

(30) Foreign Application Priority Data
Dec. 5, 2022 (GB) 2218261.2

(51) Int. Cl. G01N 17/00; G01N 17/04

(52) U.S. Cl. CPC G01N 17/008; G01N 17/006; G01N 17/04

(57) ABSTRACT

Method and apparatus to monitor for evidence prognostic of corrosion under insulation (CUI) from distributed point sensors. A range sensor is arranged to transmit and receive signals axially along a monitoring length of an insulated metallic generally cylindrical structure such as a pipeline, to measure a first parameter. The data are correlated with data from measurement of a second parameter by the distributed point sensors arranged along the monitoring length to provide a first pattern of behaviour. The range sensors can be removed and subsequent monitoring occurs solely from the number of distributed point sensors providing efficacy of monitoring. An embodiment is described with electromagnetic range sensors and relative humidity point sensors giving quantitative water accumulation and CUI risk locations along the monitoring length.

The present invention relates to monitoring for corrosion under insulation (CUI) and in particular, though not exclusively, to a method and apparatus to monitor for evidence prognostic of corrosion under insulation formation from distributed point sensors.

### BACKGROUND OF THE INVENTION

In the chemical and energy industries generally cylindrical metal structures, such as pipes, storage vessels, tanks and the like are used to transport fluids across thousands of meters. These structures are insulated and may have a metal cladding applied over the insulation. In use, moisture can build-up inside and under the thermal insulation, which causes corrosion and ultimately failure through loss of metal and/or leakage of fluid.

Removing the cladding and insulation to inspect visually for the presence of CUI is both time-consuming and costly with the possibility that removal and replacement may introduce conditions for moisture to develop. Ideally, monitoring for evidence prognostic of corrosion occurring such as the presence and phase of water is required so that remedial action can be taken before corrosion occurs.

Current methods of monitoring which do not require the removal of the cladding and insulation use: point sensors which are embedded in the insulation and optionally contact the structure; range sensors which transmit a signal between a transmitter and receiver located a distance apart along the structure; and remote sensors which are located away from the structure and receive signals from the structure, either directly or by reflection. Point sensors are limited to measurement at a single point or over a short distance; range sensors are generally complex, require more power or energy, expensive and provide measurements over the distance from which it is difficult to determine very precisely, the location for the moisture; and remote sensors are also generally complex, expensive and limited to short distances at specific locations making them unsuitable for long term monitoring.

WO2018/226433 describes an inspection system for CUI which does not require removal of the insulation and utilises two remote sensors, microwave and infrared. The system includes a device comprising transmitter and receiver horn antennas, a vector network analyzer operatively connected to the antennas, and an infrared detector. In the method, a location for inspection of the equipment is identified. A metal jacket surrounding the location is removed without stripping the thermal insulation. Microwaves are transmitted by the transmitter horn antenna at the location, and provide heating at the location. The microwaves are received by the receiver horn antenna after reflection off the equipment being examined. The vector network analyzer analyzes the microwaves. The infrared detector detects infrared waves emitted from the location and develops an infrared image of the inner surface of the equipment. Based on the analysis of the microwaves and the developed image, a programmed processor determines whether CUI exists at the location.

There are a number of disadvantages in using the system of WO2018/226433. The metal jacket cladding must be removed which gives the identified problems of potentially introducing conditions for moisture. The antenna and detector are remote sensors, arranged radially to the pipe and must be close to it, giving limited range and potential accessibility problems. Additionally, it can only inspect a specific location at a specific time, so long term monitoring over lengths of pipework is not possible as the cladding would need to be removed and the system moved along the pipeline.

It is an object of the present invention to provide a method and apparatus for monitoring for evidence prognostic of corrosion under insulation (CUI) formation which obviates or mitigates at least one disadvantage of the prior art.

### BRIEF SUMMARY OF THE INVENTION

According to a first aspect of the present invention there is provided a method of monitoring for evidence prognostic of corrosion under insulation formation comprising the steps:
(a) mounting at least one range sensor on an insulated metallic generally cylindrical structure, each range sensor having a transmitter and a receiver, the transmitter and the receiver being spaced apart by a monitoring length along the structure;
(b) mounting a plurality of point sensors on the insulated metallic cylindrical structure within the monitoring length;
(c) operating the at least one range sensor and the plurality of point sensors over a first time period and identifying a first pattern of behaviour by correlating data between a first measured parameter of the at least one range sensor and a second measured parameter of the plurality of point sensors, the first and second measured parameters being indicative of the sought evidence;
(d) removing the at least one range sensor and using the correlated data from the plurality of point sensors to monitor for the evidence over the monitoring length for further time periods to warn of potential corrosion conditions based on the correlations created.

In this way, the invention allows for the removal of the complex, expensive, range sensors and leaves cheaper, simpler point sensors to perform the monitoring which advantageously can provide more precise location data. By correlating the point sensors' data to the range sensors' data, improved efficacy of monitoring from a number of distributed point sensors is realised when the range sensors are subsequently removed and absent from the monitored length. The distributed point sensors will be able to detect evidence which alerts to abnormal or unfavourable conditions in the monitored length.

Preferably the evidence prognostic of corrosion under insulation is the probability of unwanted distributions of water. In an embodiment, the first measured parameter is water volume and the second measured parameter is relative humidity, being indicative of the proximity of or to water. In this way, the range sensors determine a quantity of any liquid and the point sensors indicate more precisely, where on, or close to, the monitoring length the water is travelling to or from and accumulating. Those skilled in the art will realise that other evidence and parameters may be monitored for and measured by each of range and point sensors, for example: evidence with a first measured parameter being electrical resistance along a monitored length of a metal and a second measured parameter being electrochemical noise at specific points on the metal surface. While the first and second parameters are different, the values and variations of either measured parameter are evidence of values and variations in metal thickness changes, which can also be caused by corrosion. The first pattern of behaviour may determine a threshold for the evidence from which, during step (d), the distributed point sensors may monitor for breaches of over the monitoring length. Preferably, during step (d) the point sensors provide an alarm signal when the threshold is reached. The alarm signal may be relayed to a central control unit to alert a user to the likelihood of potential corrosion formation at the location or locations identified by the respective point sensors and so remedial action can be taken.

The method may be used on newly installed structures or on existing structures.

Advantageously, the method includes the step of analysing the first pattern of behaviour to determine if the evidence is present in significance. If this is found, the method may include the following additional steps between steps (c) and (d):
(i) changing the values of the parameters and evidence at one or more locations along the monitoring length;
(ii) operating the at least one range sensor and the plurality of point sensors over a second time period and identifying a second pattern of behaviour between the first measured parameter of the at least one range sensor and the second measured parameter of the plurality of point sensors over the monitoring length of the structure; and
(iii) correlating the first and second patterns of behaviour.

In this way, the correlated data then reflect the variations of evidence present and hence will enable more effective monitoring of the evidence in further time periods. Preferably, at step (i) parameters and evidence are changed by repairing the structure. For water ingress, source of ingress may be mitigated and the structure re-sealed. Consequently, the second pattern of behaviour will then provide a baseline from which the threshold for re-emergence of the evidence can be calculated from the correlation of the patterns of behaviour. These additional steps are best performed when the method is used on an existing structure so that existing sources of water ingress can be identified.

Preferably, the at least one range sensor is an electromagnetic sensor. Alternatively, the at least one range sensor may be selected from a group comprising: electrical resistance, strain, acoustic, vibration, and electromagnetic sensors. The transmitter of a first range sensor may be co-housed with the receiver of a second range sensor providing a ‘transceiver’. In this way, the range sensors and signals can be ‘daisy-chained’ along the structure. Preferably, a transmitted signal from the transmitter travels axially along an insulation layer of the insulated metallic cylindrical structure. More preferably, the at least one range sensor detects the presence and measures the quantity of water within the monitoring length. The monitoring length may be up to 100 m, up to 50 m, up to 40 m, up to 30 m, up to 20 m or up to 10 m, depending on the type of range sensor selected and depending on such as the geometrical, constructional and material features of the structure along the monitoring length. By daisy-chaining the range sensors great distances can be monitored. Where the at least one range sensor is an electromagnetic sensor the monitoring length is typically up to 40 m for common pipes, claddings and insulations' features, although much greater monitoring lengths may be possible. In a preferred embodiment, the range sensors are those in the Wi-Corr® CUI Quanta range sensing system offered by 3-Sci Limited, UK.

Preferably, the point sensors are humidity sensors. Alternatively, the point sensors may be selected from a group comprising: gas detection/concentration, pH, temperature, electrical resistance, electrochemical noise, pressure, force, vibration, strain, flow rate, magnetic field (static and dynamic (i.e. high frequency/electromagnetic), electric field, electrical capacitance, salinity, liquid level and wall thickness for metal loss. The point sensors may measure more than one parameter. The point sensors may be spaced any distance apart and distributed non-uniformly so that they are located closer to potential leak points such as low points, bends and joints around the insulated metallic cylindrical structure. In a preferred embodiment the point sensors are the Wi-Corr® CUI Proximity sensors offered by 3-Sci Limited, UK.

Preferably, the insulated metallic cylindrical structure includes an electrically-conducting surface over the insulation of the insulated metallic cylindrical structure. The electrically-conducting surface may be the cladding present on the structure. Alternatively, the method may include the step of applying the electrically-conducting surface to the insulation in the form of a coating. In this way, range sensing electromagnetic measurements are achievable.

Preferably, the at least one range sensor is mounted in the insulation. In this way, the metallic cylindrical structure and the metallic cladding provide a coaxial transmission path. The at least one range sensor may optionally contact the metallic cylindrical structure. In this way, signals can be passed axially along the metallic structure. The transmitter and/or receiver may comprise an antenna for electromagnetic measurements.

Preferably, the plurality of point sensors are mounted in the insulation. In this way, the parameter can be measured directly at or in close proximity to, the surface of the insulated metallic cylindrical structure.

Preferably, the method includes recording weather data at the location of the metallic cylindrical structure. The weather data may be temperature, humidity and/or precipitation/rainfall. Alternatively, the method may include accessing weather data from a local weather station. In this way, features of these environmental data can be used to interpret the first and second patterns of behaviour.

The insulated metallic generally cylindrical structure may be a pipeline, a storage vessel or a tank. There may be different types of insulated metallic generally cylindrical structures connected together. In this way, large plants such as refineries can be monitored.

According to a second aspect of the present invention there is provided apparatus to monitor for evidence prognostic of corrosion under insulation formation on an insulated metallic generally cylindrical structure comprising: at least one range sensor comprising a transmitter and a separate receiver configured to be temporarily located a first distance apart on the structure and measure the parameter over the first distance, a signal generator to provide a signal for transmission by the transmitter axially along insulation of the structure; a local processor and memory storage for gathering and storing received data of the received signal; a plurality of point sensors configured to locate upon the structure and provide detected data of the measured parameter; a control unit configured to receive the received data and the detected data; a processor to analyse the received data and the detected data; and a display to show calculated data indicative of potential corrosion.

In this way, range sensors can be temporarily used in order to provide data to correlate with point sensors' data, so that point sensors only can be subsequently used as a monitoring system for monitoring for evidence indicative of potential future CUI on an insulated metallic generally cylindrical structure.

Preferably, the at least one range sensor is an electromagnetic sensor transmitting and receiving electromagnetic waves. Alternatively, the at least one range sensor may be selected from a group comprising: electrical resistance, strain, acoustic, vibration and electromagnetic sensors. Preferably there is a plurality of range sensors. The receiver of a first range sensor may be combined with the transmitter of a second range sensor providing a ‘transceiver’, with the receiver of the second range sensor combined with a transmitter of a third range sensor to provide a daisy-chain arrangement of transceivers. In this way, the signal generator remains with the transmitting function and the processor and memory is with the receiving function. In a preferred embodiment, the range sensors are those in the Wi-Corr® CUI Quanta range sensing system offered by 3-Sci Limited, UK.

Preferably the at least one range sensor further includes a second transceiver. This second transceiver transmits received data to the processor. This second transceiver may also receive control signals from the processor. In an embodiment the processor and display are in the control unit. In this way, the data are transmitted wirelessly to an operator's office remote from the monitoring length location for autonomous, remote monitoring.

Preferably, the at least one range sensor is configured to locate in an insulating layer of the insulated metallic generally cylindrical structure.

Preferably, the point sensors are comprised of humidity sensors. Alternatively, the point sensors may be selected from a group comprising: gas detection/concentration, pH, temperature, electrical resistance, electrochemical noise, pressure, force, vibration, strain, flow rate, magnetic field (static and dynamic (i.e. high frequency/electromagnetic)), electric field, electrical capacitance, salinity, liquid level and wall thickness for metal loss. The point sensors may measure more than one parameter. In a preferred embodiment the point sensors are the Wi-Corr® CUI Proximity sensors offered by 3-Sci Limited, UK.

Preferably, the plurality of point sensors are configured to locate in an insulating layer of the insulated metallic cylindrical structure.

The insulated metallic cylindrical structure may be a pipeline, a storage vessel or a tank. There may be different types of insulated metallic cylindrical structures connected together. In this way, large plants such as refineries can be monitored.

Preferably, the apparatus further includes weather measurement sensors. The weather measurement sensors may measure temperature, humidity, wind speed and/or precipitation/rainfall. More preferably, the weather measurement sensors include local processors and transceivers to transmit environmental data to the apparatus processor. Alternatively the apparatus processor may be configured to accept data from a local weather station.

In the description that follows, the drawings are not necessarily to scale. Certain features of the invention may be shown exaggerated in scale or in somewhat schematic form, and some details of conventional elements may not be shown in the interest of clarity and conciseness. It is to be fully recognized that the different teachings of the embodiments discussed below may be employed separately or in any suitable combination to produce the desired results.

Accordingly, the drawings and descriptions are to be regarded as illustrative in nature, and not as restrictive. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes.

All numerical values in this disclosure are understood as being modified by “about”. All singular forms of elements, or any other components described herein including (without limitations) components of the apparatus are understood to include plural forms thereof.

### BRIEF DESCRIPTION OF THE SEVERAL VIEWS OF THE DRAWINGS

Embodiments of the present invention will now be described, by way of example only, with reference to the accompanying drawings, of which:

FIG. 1 is a schematic illustration of a pipeline including apparatus to monitor for evidence prognostic of corrosion under insulation formation according to an embodiment of the present invention;

FIG. 2 is a schematic cross-sectional view of a pipeline including apparatus to monitor for evidence prognostic of corrosion under insulation formation according to an embodiment of the present invention;

FIG. 3 is a graph of water content versus time from a range sensor over a first time period in apparatus according to an embodiment of the present invention;

FIG. 4 is a graph illustrating local rainfall weather data over the first time period;

FIG. 5 is a graph of relative humidity versus time from two point sensors over the first time period in the apparatus according to an embodiment of the present invention;

FIG. 6 is a graph of water content versus time from the range sensor of FIG. 3 over a second time period according to an embodiment of the present invention;

FIG. 7 is a graph illustrating local rainfall weather data over the second time period;

FIG. 8 is a graph of relative humidity versus time from the two point sensors of FIG. 5 over a second time period according to an embodiment of the present invention; and

FIG. 9 is a graph of relative humidity versus time from a point sensor in apparatus according to an embodiment of the present invention.

### DETAILED DESCRIPTION OF THE INVENTION

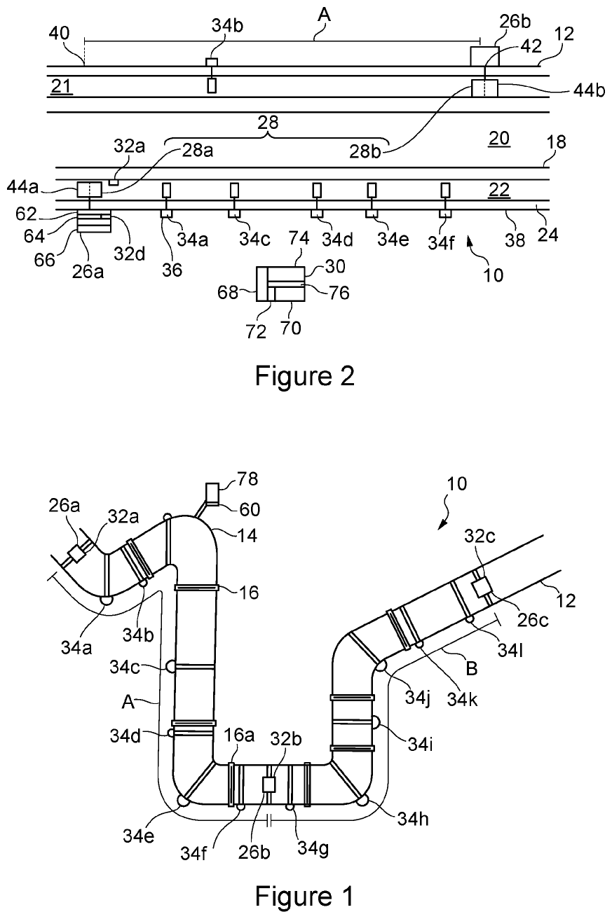

Referring initially to FIG. 1 of the drawings there is illustrated apparatus, generally indicated by reference numeral 10, to monitor for evidence prognostic of corrosion under insulation formation on an insulated metallic generally cylindrical structure according to an embodiment of the present invention. Apparatus 10 is located on a length of pipeline 12. Pipeline 12 is an example of a metallic cylindrical structure used to carry fluids which can be found in many industries such as at oil and gas refineries, chemical plants, food and beverage manufacturers, oil and gas upstream transport, power plants, pulp and paper mills, and pharmaceutical producers. The pipeline 12 can be many hundreds of meters in length and, as illustrated, may have multiple bends 14 and joints 16.

Pipeline 12 is a metallic cylindrical structure formed as illustrated in FIG. 2. An inner metallic pipe 18, typically steel such as stainless steel, carbon steel and low alloy steels but can be formed of other metals, carries the fluid 20 being transported. The inner pipe 18 has a layer of insulation 22 arranged around it. The insulation 22 is any thermal insulation such as mineral wools (e.g. ‘Rockwool’), Calcium Silicate, glass wools or solid, aerated foams. An outer cladding or other sheath 24 is around the insulation providing an outer shield. The cladding 24 is also metallic or of other electrical conductor so as to provide an insulation layer sitting between two conductive cylindrical surfaces to effectively form a coaxial transmission line. This arrangement allows for the propagation of electromagnetic waves through the insulation of the pipeline 12. For monitoring, the cladding 24 may be added an electrically conducting coating if electrical conductivity it is not already present on the cladding. Such a coating may be sprayed on or painted on.

Range sensing control units 26a-c are arranged on the pipeline cladding 24 separated by monitoring lengths A, B respectively. While only three long range sensing units 26a-c are shown, it will be appreciated that there may by any number. Each sensing unit 26 a-c includes a transceiver or a transmitter and separate receiver. A range sensor 28 comprises a transmitter 28a and a receiver 28b separated by the monitoring length. Accordingly, each sensing unit 26a-c will have a transmitter from one range sensor co-housed with a receiver of a neighbouring range sensor. Accordingly, the range sensors 28 can be daisy-chained to monitor a greater length of the insulation 22. In the preferred embodiment the range sensors 28 are electromagnetic sensors with the transceivers being antenna as is known in the art. Alternatively the range sensors 28 can comprise any sensors which transmit a signal to pass axially along a length of the insulation 22 and be received at the end of the monitoring length. Known long range sensors are electromagnetic, acoustic, strain, vibration, and electrical resistance. In a preferred embodiment the range sensors are those found in the Wi-Corr® CUI Quanta sensing system offered by 3-Sci Limited, UK. Other types of range sensors exist such as thermal imaging (i.e. broad area IR temperature sensing) and radiography (X rays, Neuron Back Scatter) but these are favoured less as they cannot be retro-fitted, often have limited range and are more technically complex with increased safety issues. The transmitter 28a and receiver 28b of the range sensor 28 can be spaced apart by large distances of typically up to 40 m and the signal can go around bends 14, cross tees and pass insulated joints 16 around the pipeline 12 as is known in the art. Additionally, the transmitter 28a and receiver 28b can be located at different radial locations and different circumferential positions with respect to each other; for example they may be at 3 o'clock and 9 o'clock on the periphery of the pipeline 12. If desired, the transmitter 28a and/or receiver 28b can comprise a plurality of each arranged circumferentially around the pipeline 12. Such an arrangement is described in WO2007/062221 and offered by Wavetrue Inc, USA, herein incorporated by reference.

As shown in FIG. 2, the transmitter 28a and receiver 28b are positioned within the insulation layer 22. The sensing control unit 26a-c includes a signal generator 62, a processor 64 and a separate transceiver 66 to allow for remote control of the transmissions and to send the received data to a central control unit 30. It will be appreciated that the sensor units 26 may be wired together and to the central control unit 30 and/or be wirelessly connected to each other and/or the central control unit 30. The sensor control units 26a-c may also have attached to them and placed in the insulation or on the pipe surfaces, temperature sensors 32a-c to provide distributed monitoring of temperature along the insulation or on the pipe outer surface. The sensor control units 26a-c may also have embedded inside them, temperature sensors 32d-f to provide monitoring of temperature at the location where the sensor control units 26a-c are placed.

Point sensors 34a-l are also arranged along the outside of the pipeline 12. There will be a number of point sensors 34a-l arranged along each monitoring length A, B. The point sensors may typically be between 1 m to 5 m to 10 m apart. The number shown in FIG. 1 is only for illustration purposes and the point sensors 34a-l can be distributed across the entire outside of the pipeline 12. The point sensors 34a-l in the preferred embodiment are humidity sensors as are known in the art. Other point sensors 34 may, for example, measure gas detection/concentration, pH, temperature, electrical resistance, electrochemical noise, pressure, force, vibration, strain, flow rate, magnetic field (static and dynamic (i.e. high frequency/electromagnetic)), electric field, electrical capacitance, salinity, liquid level and wall thickness for metal loss. In a preferred embodiment the point sensors 34a-l are the Wi-Corr® CUI Proximity sensors offered by 3-Sci Limited, UK. As a point sensor 34a-l only measures at the location it is placed, so these point sensors will be preferably mounted in locations where fluids are more likely to concentrate, such as at the lower points of the bends 14 or where the ingress of fluid could occur, such as at the joints 16 in the pipe 18 or cladding 24, as well as being distributed along the monitoring length. The point sensors' 34a-l sensing elements are detecting changes in the insulation layer 22, see FIG. 2 and are often deployed in the insulation layer. Each point sensor 34a-l has a module 36 located on the surface 38 of the cladding 24. Module 36 transmits and receives data for the point sensor 34a which may be cabled to the nearest sensor control unit 26a-c, or wirelessly transmitted directly to the central control unit 30. A point sensor 34a-l may measure more than one parameter such as humidity and temperature.

The central control unit 30 can be on-site or remote and includes a transceiver 68 for communication with the sensor units 26a-c and modules 36, a processor 70 for analysing the collected data, memory storage 72 for the data, a display 74 and input controls 76. Each sensor 28, 34a-l will have a geolocation recorded at its installation to determine its position on or around the pipeline 12 independently and relative to the other sensors 28a-c, 34a-l. The central control unit 30 will also have access to weather data at the pipeline 12 possibly via further sensors 78 (see FIG. 1). Alternatively, weather data can be collected from a local weather station and inputted to the central control unit 30.

While FIGS. 1 and 2 show both range sensors 28 and point sensors 34a-l on the pipeline 12, this is for illustrative purposes only and the range sensors 28 may be located on the pipeline independently of the point sensors 34a-l. Additionally, the range sensors 28 will be removed to leave only the point sensors 34a-l as will be described in the accompanying method. The apparatus 10 is therefore configured to be retro-fitted to operating pipelines 12 or other insulated metallic cylindrical structures.

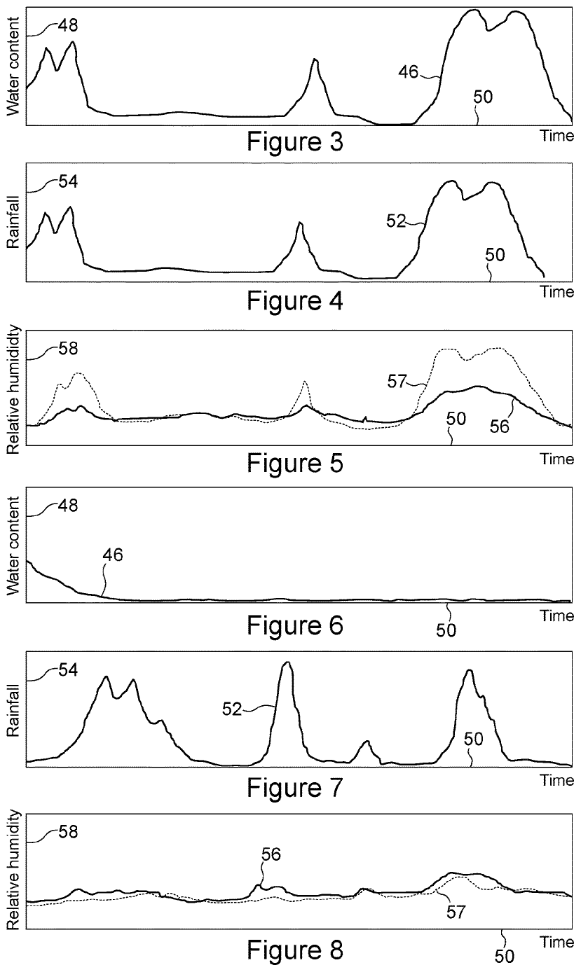

In use, a pipeline 12 is selected along which monitoring for potential CUI is desired to be carried out. A transmitter 28a of a range sensor 28 is located at a first position 40. In this embodiment, the transmitter 28a is an antenna 44a, which is inserted into the insulation layer 22 and the opening sealed at the cladding surface 24. A receiver 28b is located further along the pipeline 12 at a second location 42, separated by a monitoring length A, with an antenna 44b being similarly located in the insulation layer 22. Each antenna 44a, b is thus both a transmitter and a receiver for neighbouring sensors 28 to form a range sensing system 28 in a daisy chain arrangement. Each antenna 44a,b is connected to a sensor unit 26a, b respectively arranged on the surface 38 of the cladding 24 which may be strapped or otherwise held around the insulation 22 surrounding the pipeline 12. In the preferred embodiment, sensor unit 26a is controlled remotely from a central control unit 30 to produce electromagnetic waves at the antenna 44a at a selected frequency. The frequency will be dependent on the dimensions of the annulus 21 containing the insulation 22, the materials of the inner pipe 18, the cladding 24 and the insulation 22 material. Range sensing system 28 measures a parameter that is indicative of evidence prognostic of corrosion formation i.e. the likelihood of corrosion occurring in the future. In the preferred embodiment the parameter is moisture. The moisture may be considered as any liquid but preferably water. Liquid content in the annulus 21 is measured by sending an EM guided wave along the annulus 21 containing the insulation layer 22 to the receiver 28b and the received signal transmitted back to the control unit 30 from the sensor unit 26b. Some processing of the received signal can be performed in the sensor unit 26b. Due to the nature of the transmitted electromagnetic waves in the annulus 21, the continuous length of the pipeline between the two units 26a,b is monitored, typically up to a length of around 40 metres. Working in partnership, the two units 26a, b are able to detect and quantify the amount of liquid present in the insulation in real time. The electromagnetic wave is able to travel around bends 14 and tees of the pipeline 12 insulation 22. Using algorithms to assess the environment within the thermal insulation 22 by means of the information contained within the received signals, it is then possible to determine liquid presence and amount within the annulus 21 between the transmit and receive antennas 44a,b. An initial measurement can be made to provide a baseline for estimated liquid content or preferably, the data are analysed in real-time with monitoring occurring over longer durations, typically many hours or several days. The time between measurements in the monitoring interval needs to be short enough so that any temperature variations are not sufficient to evaporate collected liquid before it can be detected. A typical result 46 is shown in the graph of FIG. 3 of water content 48 against time 50. Weather data 52, FIG. 4, are also collected and the closely-corresponding conditions around the pipeline 12 of precipitation 54 with the insulation's water content 48 is demonstrated. The range sensing system 28 therefore provides quantitative monitoring of the liquid presence and amount (first parameter) around the pipeline 12 within the monitoring length A as a means of monitoring for moisture as evidence of the likelihood of potential CUI.

At the same time, point sensors 34a-l are mounted along the monitoring length A, at approximately every 1 to 5 or up to 10 metres and can be preferentially located at low points, cladding gaps and near joints in pipe 16 or cladding 18 where fluids are more likely to enter and/or collect. The point sensors 34a-f are also located in the insulation layer 22, sealed at the cladding 24 and connected to modules 36a-f to transmit received data to the central control unit 30 in real-time. In the preferred embodiment, the point sensors 34a-l measure relative humidity which may be indicating moisture presence within or close to the monitored length. However, unlike the range sensing system 28, the point sensors 34a-l cannot accurately measure the total water quantity over the full length of the insulation around the pipeline 12 and do not measure the water content continuously along the pipeline monitoring length A. Instead, the point sensors 34a-l can provide an indication of the location along or close to the monitoring length at which moisture is gathering. Data are collected from the point sensors 34a-l over a same time period which is illustrated, for two sensors 34c 56 and 34f 57, in FIG. 5 as relative humidity 58 against time 50 which shows a pattern of behaviour for the point sensors 34a-l over the monitoring length A. It is evident that the point sensor 34f experienced higher levels of relative humidity than that of sensor 34c. Comparing the data from the range sensor 28 with the point sensors 34a-l, a first pattern of behaviour between the range sensor 28 and the plurality of point sensors 34a-l for the evidence of potential moisture over the monitoring length A is realised. In this first pattern of behaviour it is evident that moisture build up in the insulation 22 at periods of rainfall has occurred and that the moisture build-up may be closer to the point sensor 34f. A visual inspection of the pipeline 12 around the location of the point sensor 34f to determine if there is a leak point at which water ingress could then be undertaken. In FIG. 1, sensor 34f is next to a joint 16a and the region near joint 16a can be inspected, the cladding 24 repaired and resealed. The insulation 22 at the joint 16a may be replaced or at least then dried out. Such remedial work will have changed the existing and future liquid quantities in the insulation 22.

Measurements are continued from the range sensor 28 and the point sensors 34a-l providing further graphs, FIGS. 6, 7 and 8 to compare to those of FIGS. 3, 4 and 5. With the earlier repair performed it is now seen that the liquid measured by the range sensor 28 remains low along with comparatively lower relative humidity, regardless of large amounts of rainfall. The relative humidity still vary dependent on the weather conditions as rainfall and temperature will affect the humidity within the insulation. FIGS. 6 and 8 indicate a second pattern of behaviour between the range sensor 28 and the plurality of point sensors 34a-l for the measured parameter of moisture over the monitoring length A.

Using the first and second patterns of behaviour, the data and the trends of the point sensors 34a-l are analysed and correlated with the range sensors' 28 data. From the point sensor data alone, an indication of potential moisture content in the pipeline can be given at each of the point sensor 34a-l locations and inferred for positions in between and outside of the monitoring length in which the point sensors are located. This allows the more complex range sensor system 28 to be removed from the pipeline 12. The distributed point sensors 34a-l can now be used to monitor the monitoring length A of the pipeline 12 for potential CUI through identification of anomalous trends in the data they provide.

The range sensor 28 can be moved to another monitoring length around the pipeline 12 and the method repeated to establish a further distributed set of point sensors to monitor for potential CUI on a further monitoring length. Alternatively and/or additionally, other range sensors can be located along the pipeline 12 length, so that the method is carried out in parallel over multiple monitoring lengths to cover great lengths of pipelines and other structures. As the data can be sent and processed remotely from the pipeline 12, the distributed point sensors left in place after the range sensors are removed provide a real-time monitoring system for the presence of moisture build-up indicative of possible formation of CUI. This allows remedial work to be undertaken before the corrosion has occurred and thus limits damage and failures in the structures being monitored.

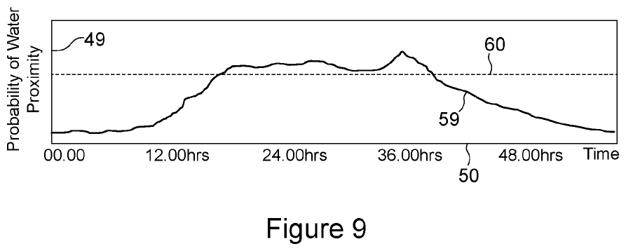

From the first and second patterns of behaviour, a threshold value can be set for the evidence, such as related to the probability of water close proximity for the embodiment described. The apparatus may then be set to provide an alarm when the point sensors indicate a measurement above the threshold. FIG. 9 shows a graph 59 of probability of water proximity 49 measurements at a point sensor over time 50 indicating that for a two day period the values were above the threshold 60. An alarm or other alert could be signalled to a user and the user can decide to inspect the location and/or monitor the data in greater detail.

It will be realised that had the range sensor 28 and distributed point sensors 34a-l been located on a pipeline 12 which had no fluid ingress to the insulation, then the initial measurements would have shown the results of FIGS. 6 and 8. These results would then indicate a first pattern of behaviour between the measured parameters of liquid content and relative humidity. This correlated data are then considered as a baseline from which anomalies are monitored by the distributed point sensors 34a-l when the range sensor 28 is removed and any threshold levels set can be determined from pre-existing or additional data on other structures with similar structural and operational features.

The principal advantage of the present invention is that it provides a method and apparatus for monitoring for potential CUI using only distributed point sensors with the efficacy of more complex range sensing systems.

A further advantage of the present invention is that it provides an opportunity for rapid and easy installation on live process plant—i.e. can be fitted on existing, operational plant. It can also be fitted during initial construction of a process plant. Accordingly, the system arising from this invention may be deployed in a remote environment providing, autonomously-gathered, real-time data and analysis of any parameter indicative of CUI such as liquid ingress and changes at all points inside the insulation alongside the pipe (or similar containment vessel) without the need for human interaction. Unseen and costly CUI can therefore be avoided and pipe leakages can be detected at the earliest possible time.

We claim:

1. A method of monitoring for evidence prognostic of corrosion under insulation formation comprising the steps:
(a) mounting at least one range sensor on an insulated metallic generally cylindrical structure, each range sensor having a transmitter and a receiver, the transmitter and the receiver being spaced apart by a monitoring length along the structure;
(b) mounting a plurality of point sensors on the insulated metallic cylindrical structure within the monitoring length;
(c) operating the at least one range sensor and the plurality of point sensors over a first time period and identifying a first pattern of behaviour by correlating data between a first measured parameter of the at least one range sensor and a second measured parameter of the plurality of point sensors, the first and second measured parameters being indicative of the evidence;
(d) removing the at least one range sensor and using the correlated data from the plurality of point sensors to monitor for the evidence over the monitoring length for further time periods to warn of potential corrosion conditions based on the correlations created.

2. The method according to claim 1 wherein the evidence is the probability of the close proximity of liquid water.

3. The method according to claim 1 wherein the first measured parameter is liquid content and the second measured parameter is relative humidity.

4. The method according to claim 1 wherein the correlated data are used to determine a threshold for the evidence and during step (d) the point sensors provide an alarm signal when the threshold is breached.

5. The method according to claim 1 wherein the first pattern of behaviour is analysed to determine if the evidence is significantly high and the method includes the following additional steps between steps (c) and (d):
(i) changing the value of the parameters and evidence at one or more locations along the monitoring length;
(ii) operating the at least one range sensor and the plurality of point sensors over a second time period and identifying a second pattern of behaviour between the first measured parameter of the at least one range sensor and the second measured parameter of the plurality of point sensors over the monitoring length of the structure; and
(iii) correlating the first and second patterns of behaviour.

6. The method according to claim 5 wherein, at step (i) the values of the parameter and evidence are changed by repairing the structure to prevent moisture arriving in the insulation.

7. The method according to claim 1 wherein a transmitted signal from the transmitter travels axially along an insulation layer of the insulated metallic generally cylindrical structure.

8. The method according to claim 1 wherein the method includes the step of applying an electrically conducting layer over insulation of the insulated metallic generally cylindrical structure.

9. The method according to claim 1 wherein the at least one range sensor is mounted in the insulation.

10. The method according to claim 1 wherein the plurality of point sensors are mounted in the insulation.

11. The method according to claim 1 wherein the method includes obtaining weather data in the time periods.

12. The method according to according to claim 1 wherein the method includes the step of collecting data from the range sensors and point sensors remotely at a central control unit.

13. The method according to claim 1 wherein the range sensors are electromagnetic sensors with the transmitter and receiver utilising antennas to transmit and receive a signal at a selected bandwidth and the plurality of point sensors are relative humidity sensors.

14. The method according to claim 1 wherein the insulated metallic generally cylindrical structure is one or more of a group comprising: a pipeline, pipelines, a storage vessel and a tank.

15. Apparatus to monitor for evidence prognostic of corrosion under insulation formation on an insulated metallic generally cylindrical structure comprising: at least one range sensor comprising a transmitter and a separate receiver configured to be temporarily located a first distance apart on the structure and measure the parameter over the first distance, a signal generator to provide a signal for transmission by the transmitter axially along insulation of the structure; a local processor and memory storage for gathering and storing received data of the received signal; a plurality of point sensors configured to locate upon the structure and provide detected data of the measured parameter; a control unit configured to receive the received data and the detected data; a processor to analyse the received data and the detected data; and a display to show calculated data indicative of potential corrosion.

16. Apparatus according to claim 15 wherein the at least one range sensor is selected from a group comprising: electrical resistance, strain, acoustic, vibration and electromagnetic sensors.

17. (canceled)

18. Apparatus according to claim 15 wherein the transmitter of a first range sensor is combined with the receiver of a second range sensor providing a signal transceiver.

19. Apparatus according to claim 15 wherein the at least one range sensor includes a data transmit transceiver to transmit received data to the processor.

20. Apparatus according to claim 15 wherein the processer and display are in the control unit.

21. (canceled)

22. Apparatus according to claim 15 wherein the point sensors are selected from a group comprising: humidity, gas detection/concentration, pH, temperature, electrical resistance, electrochemical noise, pressure, force, vibration, strain, flow rate, magnetic field (static and dynamic (i.e. high frequency/electromagnetic), electric field, electrical capacitance, salinity, liquid level and wall thickness for metal loss.

23. (canceled)

24. (canceled)

25. (canceled)
